(19) United States
(12) Patent Application Publication
(10) Pub. No.: US 2026/0049183 A1
(43) Pub. Date: Feb. 19, 2026

(54) HIGH-DIELECTRIC HYDROPHOBIC POLYMER, PREPARATION METHOD AND USE THEREOF

(71) Applicants: SOUTH CHINA NORMAL UNIVERSITY, Guangdong (CN); SHENZHEN GUOHUA OPTOELECTRONICS CO., LTD., Shenzhen, Guangdong (CN)

(72) Inventors: Guofu ZHOU, Panyu District, Guangzhou, Guangdong (CN); Wangqiao CHEN, Panyu District, Guangzhou, Guangdong (CN); Hao GUO, Panyu District, Guangzhou, Guangdong (CN); Dinggui HE, Panyu District, Guangzhou, Guangdong (CN); Yuanyuan GUO, Panyu District, Guangzhou, Guangdong (CN)

(73) Assignees: SOUTH CHINA NORMAL UNIVERSITY, Guangdong (CN); SHENZHEN GUOHUA OPTOELECTRONICS CO., LTD., Shenzhen, Guangdong (CN)

(21) Appl. No.: 18/692,045

(22) PCT Filed: Nov. 30, 2023
(86) PCT No.: PCT/CN2023/135480

§ 371 Date: Apr. 18, 2025

(30) Foreign Application Priority Data
Jun. 20, 2023 (CN) 2023107371618

(51) Int. Cl. C08G 77/20; C08G 77/12; C09D 183/04

(52) U.S. Cl. CPC C08G 77/20; C08G 77/12; C09D 183/04

(57) ABSTRACT

The present disclosure relates to the technical field of high molecular materials, discloses a high-dielectric hydrophobic polymer, a preparation method and use thereof, and relates to a polymer of formula I. The polymer of the disclosure has a polarizable group that is capable of increasing its dielectric constant while maintaining its high hydrophobicity, light transmittance and low roughness, so as to achieve a low hysteresis and recoverable electrowetting contact angle at a low voltage. The polymer of the present disclosure, as a cross-linked amorphous network polymer, has an extremely low crystallinity, and a good optical transparency with the light transmittance reaching 99%, which is sufficient to meet the requirements of an electrowetting display, a liquid lens and the like on the light transmittance.

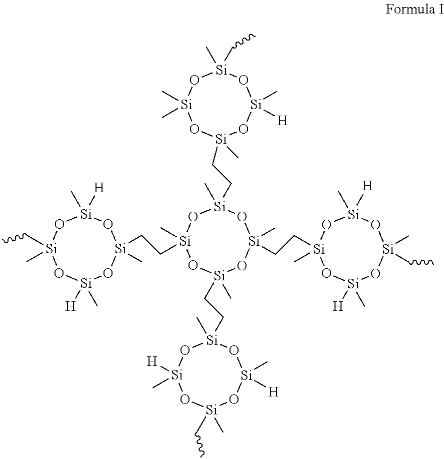

### CROSS-REFERENCE TO RELATED APPLICATIONS

The present application is a national phase entry under 35 USC § 371 of International Application PCT/CN2023/135480 filed Nov. 30, 2023, which claims the benefit of and priority to Chinese Patent Application No. 202310737161.8, filed Jun. 20, 2023, the entire disclosures of which are incorporated herein by reference.

### TECHNICAL FIELD

The present disclosure relates to the technical field of high molecular materials, and in particular to a high-dielectric hydrophobic polymer, a preparation method and use thereof.

### BACKGROUND

Electrowetting technology is a technical means to control and process a droplet by using electrowetting phenomenon, which includes an electrode, a hydrophobic dielectric layer and liquid. The main principle of the electrowetting technology is to change a contact angle of a liquid-solid phase by varying a voltage applied to the hydrophobic dielectric layer, which in turn causes the deformation of the droplet, and ultimately achieves the purpose of controlling a driving voltage to regulate a shape and a position of the droplet. The hydrophobic dielectric layer between the electrode and the droplet plays an important role in electrowetting-on-dielectric (EWOD) device, and the selection and preparation process of the dielectric layer material directly affect a performance and application of the device. The change in the contact angle of the droplet and the applied voltage satisfy the below Young-Lippmann equation:

$${γ}_{L G} ( cos {θ}_{V} + cos {θ}_{0} ) = \frac{1}{2} \frac{{ε}_{0} {ε}_{r}}{d} {V}^{2}$$

in the equation, γ_{LG} is a gas-liquid surface tension, ε₀ is a vacuum dielectric constant, Er is an effective dielectric constant of the hydrophobic dielectric layer, d is a sum of the thicknesses of the hydrophobic dielectric layers, and V is a voltage between the droplet and the electrode. In the electrowetting technology, the hydrophobic dielectric film first has to meet two conditions: 1. the dielectric constant is high, which allows to be driven at a low voltage; and 2. the initial contact angle is high, which provides feasibility for a wide range of droplet variation. In addition to this, the hydrophobic dielectric film generally requires high breakdown strength and a low roughness. The low breakdown strength will result in easy breakdown of the film, and a surface of a high roughness will affect the reversibility of electrowetting.

At present, there are two types of dielectric wetting film. One is high molecular materials such as polydimethylsiloxane (PDMS), amorphous fluorine-containing resins (Teflon AF) and Parylene-C, which have an excellent hydrophobic property, but a relatively low dielectric constant and a high driving voltage that limit their wide application in the processing of the dielectric wetting material. Taking the Teflon AF 1600 produced by DuPont Company as an example, it has a good hydrophobic property (120° contact angle), but a poor dielectric property, with a dielectric constant of 2 or less, resulting in easy breakdown due to its low dielectric strength. The other is inorganic-organic nanocomposites obtained by doping an inorganic nanoparticle with a high dielectric constant with the above high molecular material. This doping method improves the dielectric constant of the high molecular material, but also brings some innegligible issues: 1. the inorganic nanoparticle is difficult to be dispersed in a carrier of the high molecular material due to its surface effect, and so modification of the inorganic nanoparticle is required, which makes the process more complicated and the nanocomposites difficult to be mass-produced; and 2. even if the inorganic nanoparticle is uniformly doped into the high molecular material through modification, other problems will arise. Firstly, the addition of the inorganic nanoparticle will inevitably lead to an increase in film roughness, which in turn affects the reversibility and cyclicity of electrowetting, and secondly, a decrease in light transmittance will occur. For an electrowetting display, a liquid lens and other devices, the decrease in light transmittance will limit the application of the film in these devices. In addition, a complex interface structure of the composite will also lead to complex problems such as increased dielectric loss, uneven distribution of voltage and changes in toughness and strength of the film.

Another way to increase the dielectric constant of the high molecular polymer is to introduce a polar group. The dielectric constant of a material is essentially the polarizability of the material under an electric field. Four types of polarization will occur in the material under the electric field: electron polarization, ion polarization, dipole polarization and interface polarization. By introducing the polar group into the polymer, the degree of dipole polarization of the polymer is able to be enhanced, which in turn increase the dielectric constant of the polymer. Currently, a variety of polar groups have been grafted onto a side chain of polymer to increase the dielectric constant. This method increases the dielectric constant of the polymer, but at the same time, the polar group on these side chains will reduce the hydrophobicity of the polymer.

### SUMMARY

The present disclosure aims at solving at least one of the above-mentioned technical problems existing in the prior art. Therefore, it is an objective of the present disclosure to provide a high-dielectric hydrophobic polymer, a preparation method and use thereof. A dielectric constant of a high molecular film is related to its molecular polarity, and the stronger the molecular polarity, the more asymmetric polar groups there are in the molecule. The hydrophobicity of polysiloxane originates from a —CH₃ group on its surface, the introduction of the polar group while maintaining the —CH₃ group at the periphery of a molecular chain can enhance the dielectric constant, and maintain its hydrophobicity at the same time. For synthesizing a polysiloxane product According to the present disclosure, a polysiloxane product is synthesized during which the polar group is introduced in a polymerization process to enhance the final molecular polarity, which in turn increases the dielectric constant of the high molecular film while maintaining the low roughness property, and enables the molecular chain-CH₃ to retain the hydrophobicity of the polysiloxane, thereby the product having both hydrophobicity and high dielectric property, and is suitable for an electrowetting hydrophobic dielectric layer.

In order to achieve the above objective, the technical solutions used in the present disclosure are as follows:

According to a first aspect of the present disclosure, a polymer of formula I is proposed:

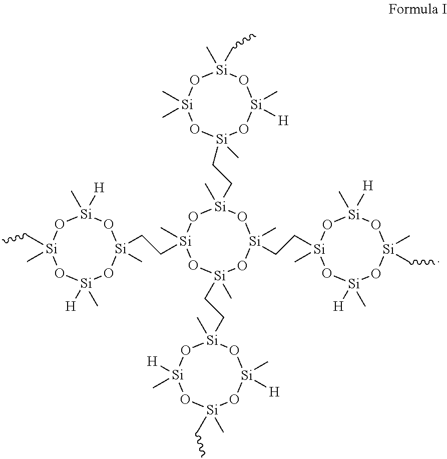

According to a second aspect of the present disclosure, a preparation method of the polymer as described above is proposed, including a step of:
mixing tetramethyltetravinylcyclotetrasiloxane (D4V) and tetramethylcyclotetrasiloxane (D4H) with an initiator for reaction, to prepare the polymer.

In some embodiments of the present disclosure, a mass ratio of the tetramethyltetravinylcyclotetrasiloxane to the tetramethylcyclotetrasiloxane is 1: (1.1-2), preferably 1: (1.3-1.6).

In some preferred embodiments of the present disclosure, the reaction is conducted at a temperature of 40° C. to 45° C. for 80 minutes to 100 minutes.

In some more preferred embodiments of the present disclosure, a mass of the initiator is 0.1% to 0.5% of a mass of the tetramethyltetravinylcyclotetrasiloxane, preferably 0.2%.

In some more preferred embodiments of the present disclosure, the initiator is a KARSTEDT catalyst.

In some more preferred embodiments of the present disclosure, the reaction is a hydrosilylation reaction.

According to a third aspect of the present disclosure, a high-dielectric hydrophobic material comprising the polymer as described above is proposed.

In some embodiments of the present disclosure, the high-dielectric hydrophobic material further includes at least one selected from the group consisting of a filler, a dye, an antioxidant, a photosensitizer, a glass fiber cloth, a thermal initiator, a light stabilizer, a plasticizer, a flame retardant, an antistatic agent and a release agent.

According to a fourth aspect of the present disclosure, a cured product comprising a cured material is proposed, wherein the cured material includes the polymer and/or the high-dielectric hydrophobic material as described above.

In some embodiments of the present disclosure, the cured product is formed from the cured material by a crosslinking reaction.

In some preferred embodiments of the present disclosure, the cured product is formed from the cured material by curing under heating; preferably, a temperature of the heating is 60° C. to 200° C. and the heating lasts for 2 hours to 4 hours; preferably, a temperature of the heating is 80° C. to 150° C. and the heating lasts for 2 hours to 4 hours; preferably, the curing under heating includes heating the cured material at 70° C. to 90° C. for 2 hours to 4 hours, and then heating the cured material at 140° C. to 160° C. for 2 hours to 4 hours.

According to a fifth aspect of the present disclosure, an article comprising the polymer and/or the high-dielectric hydrophobic material and/or the cured product as described above is proposed.

In some embodiments of the present disclosure, the article is selected from the group consisting of a high-dielectric film substrate material, a high-dielectric film, a high-dielectric constant matrix resin and a high-dielectric packaging material.

In some preferred embodiments of the present disclosure, the article comprises a substrate, and a film of the polymer and/or a film of the high-dielectric hydrophobic material and/or a film of the cured product coated on the substrate.

According to a sixth aspect of the present disclosure, a device comprising the article as described above is proposed.

In some embodiments of the present disclosure, the device is any one selected from the group consisting of an electrowetting display, a liquid lens and a digital microfluidic chip.

The beneficial effects of the present disclosure are as follows.

1. The polymer of the present disclosure itself has a polarizable group that is capable of increasing its dielectric constant while maintaining its high hydrophobicity, light transmittance and low roughness, so as to achieve a low hysteresis and recoverable electrowetting contact angle at a low voltage.

2. The polymer of the present disclosure, as a cross-linked amorphous network polymer, has an extremely low crystallinity, and a good optical transparency with the light transmittance reaching 99%, which is sufficient to meet the requirements of an electrowetting display, a liquid lens and the like on the light transmittance.

### BRIEF DESCRIPTION OF THE DRAWINGS

FIG. 1 is an infrared spectrogram, which shows an infrared spectrogram of tetramethyltetravinylcyclotetrasiloxane, tetramethylcyclotetrasiloxane, a hydrophobic dielectric layer prepared by reaction for 40 minutes, a hydrophobic dielectric layer prepared by reaction for 60 minutes, and a hydrophobic dielectric layer prepared by reaction for 80 minutes in Example 2 of the present disclosure from bottom to top;

FIG. 2 is an infrared spectrogram, which shows an infrared spectrogram of tetramethyltetravinylcyclotetrasiloxane, tetramethylcyclotetrasiloxane, a hydrophobic dielectric layer of Example 1, a hydrophobic dielectric layer of Example 2, and a hydrophobic dielectric layer of Example 3 of the present disclosure from bottom to top;

FIG. 3 shows dielectric constants of hydrophobic dielectric layers prepared by reaction for different times in Example 2 of the present disclosure;

FIG. 4 is a schematic diagram of a connection mode of an electrowetting test device in Example 2 of the present disclosure;

FIG. 5 shows a water contact angle of a hydrophobic dielectric layer film of Example 1 of the present disclosure in air;

FIG. 6 shows a water contact angle of a hydrophobic dielectric layer film of Example 1 of the present disclosure in decane;

FIG. 7 shows a variation curve of an electrowetting contact angle of a hydrophobic dielectric layer film of Example 1 of the present disclosure;

FIG. 8 is a roughness test result of a hydrophobic dielectric layer film of Example 1 of the present disclosure;

FIG. 9 is a light transmittance test result of a hydrophobic dielectric layer film of Example 1 of the present disclosure; and

FIG. 10 is a leakage current test result of a hydrophobic dielectric layer film of Example 1 of the present disclosure.

### DETAILED DESCRIPTION

The content of the present disclosure is further described in detail hereinafter with reference to particular examples. The raw materials, reagents or devices used in the example sand comparative examples can all be obtained commercially or by methods known in the art unless otherwise specified. Unless otherwise specified, the experimental or test methods are all conventional methods.

### Example 1

In this example, a dielectric layer was prepared. The specific process was as follows:
S1: mixing 0.7 part by mass of tetramethyltetravinylcyclotetrasiloxane and 1 part by mass of tetramethylcyclotetrasiloxane with 0.0014 part by mass of a Caster initiator (with a mass being 0.2% of a mass of D4V), and magnetically stirring a result mixture for reaction for 80 minutes at a temperature of 43° C. to prepare a polymer, wherein before being mixed, the tetramethylcyclotetrasiloxane was filtered by a filter having a 0.22 μm PTFE filtration film; and
S2: coating the polymer prepared in the S1 on an ITO glass, curing at a temperature of 80° C. for 3 hours, and then curing at a temperature of 150° C. for 3 hours to obtain an electrowetting hydrophobic dielectric layer, wherein during the coating, a formed film had a thickness of 1 μm, and the ITO glass had a size of 3 cm×3 cm.

### Example 2

In this example, a dielectric layer was prepared. The specific process was as follows:
S1: mixing 0.7 part by mass of tetramethyltetravinylcyclotetrasiloxane and 1 part by mass of tetramethylcyclotetrasiloxane with 0.0014 part by mass of a Caster initiator respectively, and magnetically stirring a result mixture for reaction for 40 minutes, 60 minutes and 80 minutes at a temperature of 43° C. to prepare polymers, wherein before being mixed, the tetramethylcyclotetrasiloxane was filtrated by a filter having a 0.22 μm PTFE filtration membrane; and
S2: coating the polymers prepared by reaction for different times in the S1 on an ITO glass respectively, curing at a temperature of 80° C. for 3 hours, and then curing at a temperature of 150° C. for 3 hours to obtain electrowetting hydrophobic dielectric layers, wherein during the coating, the formed films had a thickness of 1 μm, and the ITO glasses had a size of 3 cm×3 cm.

### Example 3

In this example, a dielectric layer was prepared. The specific process was as follows:
S1: mixing 0.7 part by mass of tetramethyltetravinylcyclotetrasiloxane and 1.3 parts by mass of tetramethylcyclotetrasiloxane with 0.0014 part by mass of a Caster initiator (with a mass being 0.2% of a mass of D4V), and magnetically stirring a result mixture for reaction for 80 minutes at a temperature of 43° C. to prepare a polymer, wherein before being mixed, the tetramethylcyclotetrasiloxane was filtrated by a filter having a 0.22 μm PTFE filtration film; and
S2: coating the polymer prepared in the S1 on an ITO glass, curing at a temperature of 80° C. for 3 hours and then curing at a temperature of 150° C. for 3 hours to obtain an electrowetting hydrophobic dielectric layer, wherein during the coating, a formed film had a thickness of 1 μm, and the ITO glass had a size of 3 cm×3 cm.

### Example 4

In this example, a dielectric layer was prepared. The specific process was as follows:
S1: mixing 0.7 part by mass of tetramethyltetravinylcyclotetrasiloxane and 1.4 parts by mass of tetramethylcyclotetrasiloxane with 0.0014 part by mass of a Caster initiator, and magnetically stirring a result mixture for reaction for 80 minutes at a temperature of 43° C., wherein before being mixed, the tetramethylcyclotetrasiloxane was filtrated by a filter having a 0.22 μm PTFE filtration film; and
S2: coating the polymer prepared in the S1 on an ITO glass, curing at a temperature of at 80° C. for 3 hours and then curing at a temperature of 150° C. for 3 hours to obtain an electrowetting hydrophobic dielectric layer, wherein during the coating, a formed film had a thickness of 1 μm and the ITO glass had a size of 3 cm×3 cm.

### Experimental Example 1

The dielectric layers prepared by reaction for different times in Example 2 were subjected to infrared analysis and dielectric property analysis, and the methods were provided as below.

Infrared analysis method: the films peeled from ITO glasses of Example 2 were tested for Attenuated Total Internal Reflectance Fourier Transform Infrared Spectroscopy (ATR-FTIR) with a Fourier infrared spectrometer to identify a functional group change of cyclotetrasiloxane in the reaction in a spectral range of 600 cm⁻¹ to 3,200 cm⁻¹.

Dielectric property analysis method: a copper metal electrode was plated on each of a film of Example 2 as an upper electrode, with an electrode area of 5 mm×5 mm, an ITO glass was used a bottom electrode, the upper and lower electrodes were connected to an impedance analyzer, and then a dielectric constant of the film was measured in a frequency range of 1,200 Hz to 1,000,000 Hz.

The dielectric layers prepared in Example 1, Example 3 and Example 4 were subjected to infrared analysis according to the above infrared analysis method.

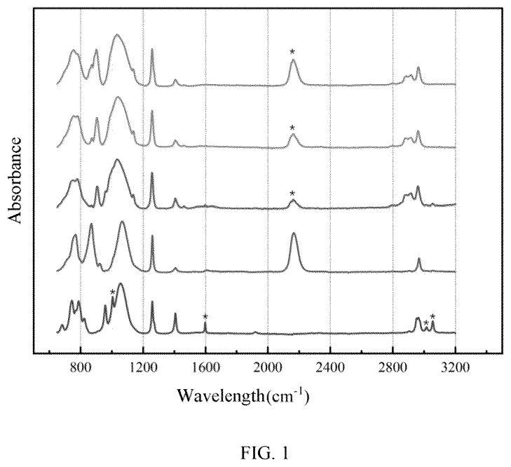

FIG. 1 is an infrared spectrogram of tetramethyltetravinylcyclotetrasiloxane (a), tetramethylcyclotetrasiloxane (b), hydrophobic dielectric layer prepared by reaction for 40 minutes (c), the hydrophobic dielectric layer prepared by reaction for 60 minutes (d) and the hydrophobic dielectric layer prepared by reaction for 80 minutes (e) in Example 2.

As can be seen from FIG. 1, firstly, the absorption peaks of vinyl (C═C) at 1,006 cm⁻¹, 1,598 cm⁻¹, 3,056 cm⁻¹ and 3016 cm⁻¹ disappears, which proves that both the tetramethyltetravinylcyclotetrasiloxane and the tetramethylcyclotetrasiloxane are subjected to a hydrosilylation, and secondly, the strength of Si—H bonds at 2,125 cm⁻¹ increases, which proves that as a reaction progresses, more and more polar groups Si—H bonds remain in the polymer network, and these polar groups will increase the dielectric constant of the hydrophobic dielectric layer.

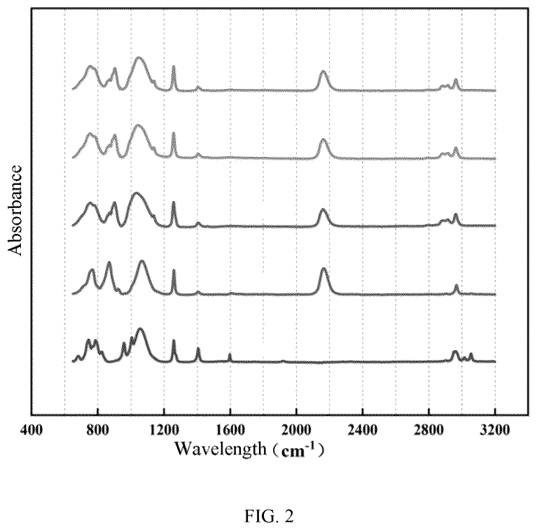

FIG. 2 is an infrared spectrogram of tetramethyltetravinylcyclotetrasiloxane (a), tetramethylcyclotetrasiloxane (b), a hydrophobic dielectric layer of Example 1 (c), a hydrophobic dielectric layer of Example 2 (d), and a hydrophobic dielectric layer of Example 3 (e).

As can be seen from FIG. 2, the products of different components have similar Si—H bond strength, and if a proportion of D4H is higher, the strength of the Si—H bond is higher, but not significant.

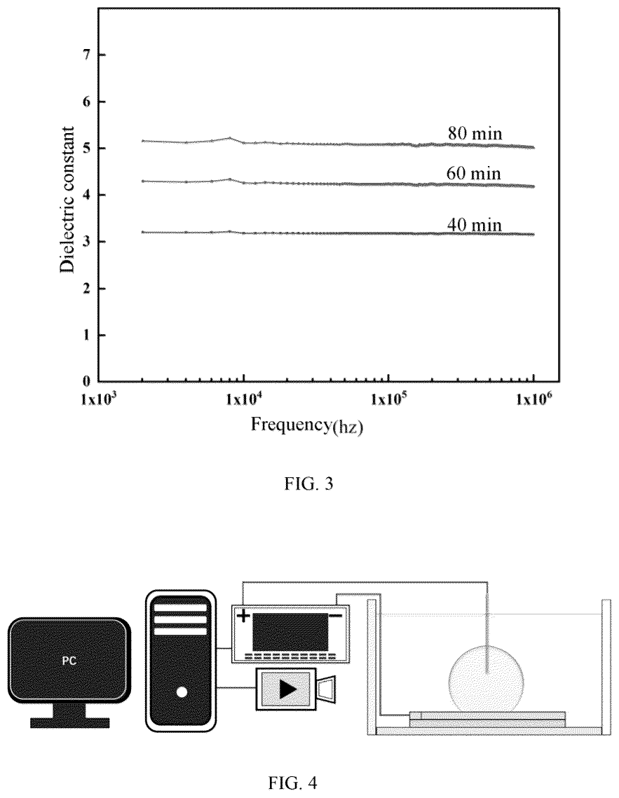

FIG. 3 shows dielectric constants dielectric layers prepared by reaction for different times in Example 2.

As can be seen from FIG. 3, the dielectric constant of the dielectric layer also increases with an increase of a reaction degree, and its final dielectric constant reaches 5.1, which is more than 2 times that of conventional polymers such as PDMS and Teflon.

### Experimental Example 2

The dielectric layer prepared in Example 1 was subjected to an electrowetting test, a roughness analysis, a light transmittance test and a breakdown test. The specific test methods were as follows.

The electrowetting test method: a circulating direct current voltage was provided by a picoammeter, a contact angle value was monitored in real time by a contact angle meter, a test droplet was 5 μL of deionized water, a copper metal probe was connected, and a hydrophobic dielectric layer was a film of Example 1. In order to ensure a stability of the electrowetting process, the droplet was subjected to electrowetting test in decane. A connection mode of a testing device is shown in FIG. 4.

The roughness analysis method: the film of Example 1 was scanned by using an AFM atomic force microscope, with a scanning area of 30 μm×30 μm, to obtain a roughness of the hydrophobic dielectric layer.

The light transmittance test method: the film of Example 1 was tested for transmittance by using an ultraviolet-visible spectrophotometer, and the test range was in visible light range (400 nm to 800 nm).

The process of the breakdown test was as follows: an increasing direct current voltage was applied to a 1 μm dielectric film by using a chip meter and a leakage current was monitored. When the leakage current rose rapidly, the film was considered to be broken down.

FIG. 5 shows a water contact angle of a hydrophobic dielectric layer film of Example 1 in air, which is about 107°.

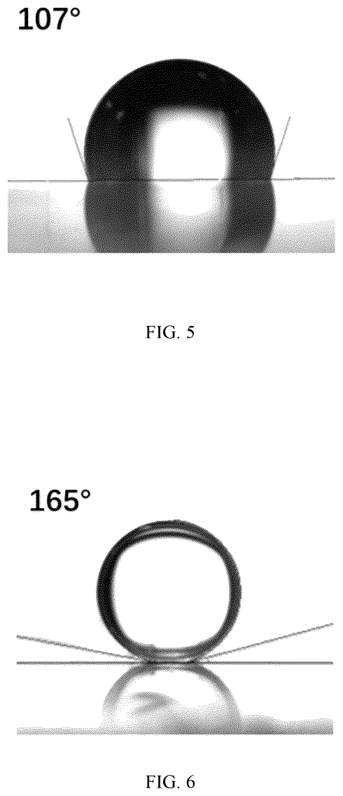

FIG. 6 shows a water contact angle of a hydrophobic dielectric layer film of Example 1 in decane, which is about 165°.

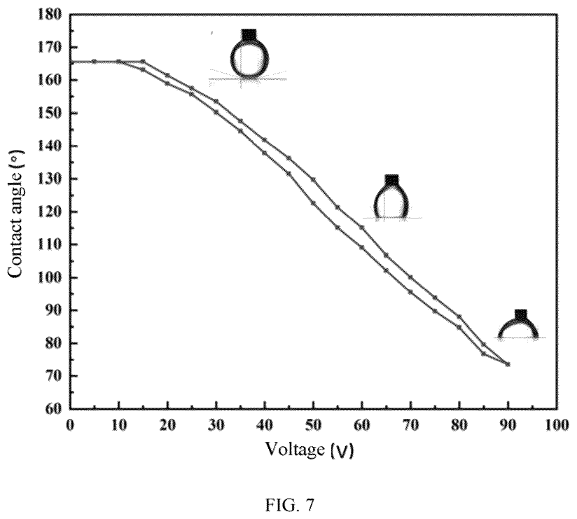

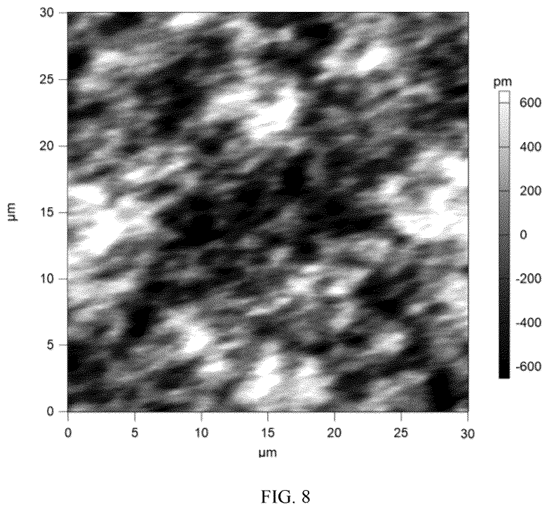

FIG. 7 shows a variation curve of an electrowetting contact angle of a hydrophobic dielectric layer film of Example 1.

As can be seen from FIG. 7, when a round-trip voltage of 90 V was applied to a 1 μm film, the contact angle of the film achieved a round-trip cycle from 165° to 70°, and the contact angle hysteresis of the film is less than 10° in the whole process, which proves the excellent electrowetting performance of the film.

FIG. 8 is a roughness test result of a hydrophobic dielectric layer film of Example 1. As can be seen from FIG. 8, the roughness Ra of the film is 262 pm. Compared with the general Teflon film roughness Ra of 4.1 nm, the dielectric layer film of the present disclosure is lower, which is also the reason for a high reversibility and low hysteresis of electrowetting contact angle of the dielectric layer film.

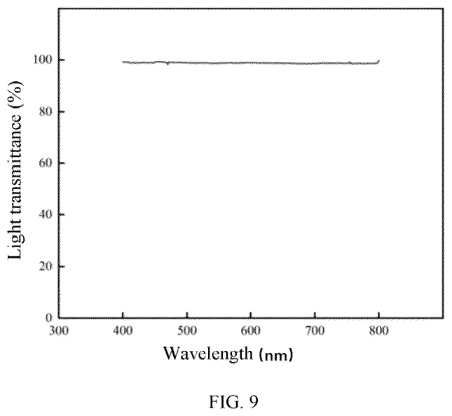

FIG. 9 is a light transmittance test result of a hydrophobic dielectric layer film of Example 1. As can be seen from FIG. 9, the polymer of the present disclosure, as a cross-linked amorphous network polymer, has an extremely low crystallinity, and a good optical transparency with the light transmittance reaching 99%, which is sufficient to meet the requirements of an electrowetting display, a liquid lens and the like on the light transmittance.

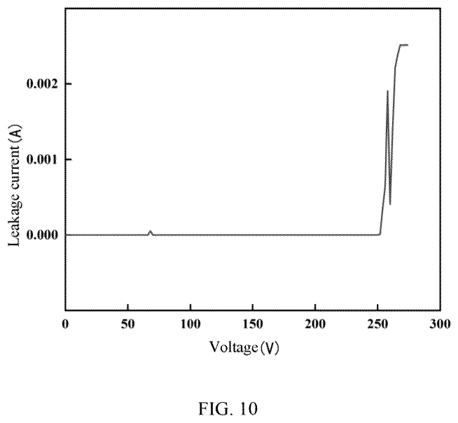

FIG. 10 is a leakage current test result of a hydrophobic dielectric layer film of Example 1. As can be seen from FIG. 10, a breakdown strength of the dielectric layer film is 252 V/μm, which is significantly higher than the breakdown voltage of Teflon AF 1600 (213 V/μm).

The above-mentioned examples are preferred examples of the present disclosure, but the examples of the present disclosure are not limited to the described examples, and any other changes, modifications, substitutions, combinations, and simplifications made without departing from the spirit and principle of the present disclosure shall all be equivalent substitutions, which are all included in the scope of protection of the present disclosure.

1. A polymer of formula I:

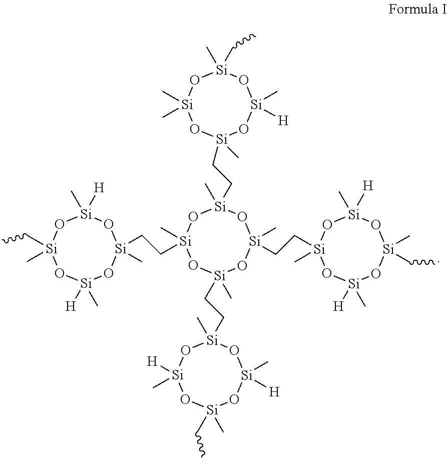

2. A preparation method of the polymer according to claim 1, comprising a step of:
mixing tetramethyltetravinylcyclotetrasiloxane and tetramethylcyclotetrasiloxane with an initiator for reaction, to prepare the polymer.

3. The preparation method of the polymer according to claim 2, wherein a mass ratio of the tetramethyltetravinylcyclotetrasiloxane to the tetramethylcyclotetrasiloxane is 1: (1.1-2).

4. The preparation method of the polymer according to claim 2, wherein the reaction is conducted a temperature of 40° C. to 45° C. for 80 minutes to 100 minutes.

5. A high-dielectric hydrophobic material, comprising the polymer according to claim 1.

6. A cured product, comprising a cured material, wherein the cured material comprises the polymer according to claim 1.

7. An article, comprising the polymer according to claim 1.

8. The article according to claim 7, wherein the article is selected from the group consisting of a high-dielectric film substrate material, a high-dielectric film, a high-dielectric constant matrix resin and a high-dielectric packaging material.

9. A device, comprising the article according to claim 8.

10. The device according to claim 9, wherein the device is any one selected from the group consisting of an electrowetting display, a liquid lens and a digital microfluidic chip.

11. A cured product, comprising a cured material, wherein the cured material comprises the high-dielectric hydrophobic material according to claim 5.

12. An article, comprising the high-dielectric hydrophobic material according to claim 5.

13. An article, comprising the cured product according tom claim 6.

14. An article, comprising the cured product according to claim 11.

15. The article according to claim 12, wherein the article is selected from the group consisting of a high-dielectric film substrate material, a high-dielectric film, a high-dielectric constant matrix resin and a high-dielectric packaging material.

16. The article according to claim 13, wherein the article is selected from the group consisting of a high-dielectric film substrate material, a high-dielectric film, a high-dielectric constant matrix resin and a high-dielectric packaging material.

17. The article according to claim 14, wherein the article is selected from the group consisting of a high-dielectric film substrate material, a high-dielectric film, a high-dielectric constant matrix resin and a high-dielectric packaging material.

18. A device, comprising the article according to claim 15.

19. A device, comprising the article according to claim 16.

20. A device, comprising the article according to claim 17.
